(19) United States
(12) Patent Application Publication
(10) Pub. No.: US 2024/0122005 A1
(43) Pub. Date: Apr. 11, 2024

(54) DISPLAY DEVICE

(71) Applicant: Samsung Display Co., LTD., Yongin-si (KR)

(72) Inventors: Jun Won CHOI, Yongin-si (KR); Jun Young MIN, Yongin-si (KR); Jun Yong AN, Yongin-si (KR)

(21) Appl. No.: 18/234,305

(22) Filed: Aug. 15, 2023

(30) Foreign Application Priority Data
Oct. 11, 2022 (KR) 10-2022-0130078
Feb. 9, 2023 (KR) 10-2023-0017488

(51) Int. Cl. H10K 59/131; G09G 3/3233; H10K 59/121

(52) U.S. Cl. CPC H10K 59/131; G09G 3/3233; H10K 59/1216; G09G 2300/0426; G09G 2300/0819; G09G 2300/0842; G09G 2320/0233; G09G 2330/04

(57) ABSTRACT

A display device includes: a first display area including a plurality of data lines extending in a first direction; a second display area at one side of the first display area, comprising a plurality of data lines shorter than the data lines of the first display area; a first non-display area adjacent to the first display area; and a second non-display area adjacent to the second display area, comprising a plurality of load matching units respectively connected to the plurality of data lines of the second display area and configured to compensate for load capacitance of the plurality of data lines of the second display area.

### CROSS-REFERENCE TO RELATED APPLICATION

The present application claims priority to and the benefit of Korean Patent Application No. 10-2022-0130078 filed on Oct. 11, 2022, and Korean Patent Application No. 10-2023-0017488 filed on Feb. 9, 2023, in the Korean Intellectual Property Office, the entire content of each of which is incorporated herein by reference.

### BACKGROUND

### Field

Aspects of some embodiments of the present disclosure relate to a display device.

### Description of the Related Art

With the advancement of the information age, consumer demand for display devices for displaying images has increased with various forms. For example, display devices have been applied to various electronic devices such as smart phones, digital cameras, laptop computers, navigators, and smart televisions. Display devices may include flat panel display devices such as liquid crystal display devices, field emission display devices, and organic light emitting display devices. Among the flat panel display devices, light emitting display devices generally include light emitting elements in which each of pixels of a display panel may self-emit light, thereby displaying images even without a backlight unit that provides the display panel with light. The light emitting element may be an organic light emitting diode that uses an organic material as a fluorescent material or an inorganic light emitting diode that uses an inorganic material as a fluorescent material.

The above information disclosed in this Background section is only for enhancement of understanding of the background and therefore the information discussed in this Background section does not necessarily constitute prior art.

### SUMMARY

According to some embodiments of the present disclosure, a display device may relatively uniformly maintain luminance of a display panel having a shape of an atypical polygon or an asymmetrical polygon.

The characteristics of embodiments according to the present disclosure are not limited to those mentioned above and additional characteristics of embodiments according to the present disclosure, which are not mentioned herein, will be more clearly understood by those skilled in the art from the following description of the present disclosure.

According to some embodiments, a display device includes a first display area including a plurality of data lines extending in a first direction, a second display area at one side of the first display area, comprising a plurality of data lines shorter than the data lines of the first display area, a first non-display area adjacent to the first display area, and a second non-display area adjacent to the second display area, comprising a plurality of load matching units respectively connected to the plurality of data lines of the second display area to compensate for load capacitance of the plurality of data lines of the second display area.

According to some embodiments, the second display area may comprise a plurality of data lines having lengths different from each other. According to some embodiments, the second non-display area may comprise a plurality of load matching units having lengths different depending on the length of the data lines of the second display area.

According to some embodiments, as the length of the data line becomes short, the length of the load matching unit may be increased. As the length of the load matching unit is increased, load capacitance of the load matching unit may be increased.

According to some embodiments, the load matching unit may include a plurality of compensation capacitors arranged in a line, and the length of the load matching unit may be proportional to the number of the compensation capacitors.

According to some embodiments, the second display area may further comprise a driving voltage line extending in parallel with the data line. According to some embodiments, each of the plurality of compensation capacitors may include a first capacitor electrode electrically connected to the data line, and a second capacitor electrode electrically connected to the driving voltage line.

According to some embodiments, the first capacitor electrodes of the plurality of compensation capacitors may be on a first layer and electrically connected to each other, and the second capacitor electrodes of the plurality of compensation capacitors may be on a second layer on the first layer and electrically connected to each other.

According to some embodiments, the first non-display area may comprise a pad portion, a plurality of first fan-out lines connected to the pad portion, and a first circuit part connected between the plurality of first fan-out lines and the plurality of data lines. According to some embodiments, the second non-display area may comprise a plurality of second fan-out lines connected to the pad portion, a second circuit part connected to the plurality of second fan-out lines, and a plurality of lead lines connected between the second circuit part and the second display area.

According to some embodiments, the second circuit part may comprise a demultiplexer outputting a data voltage received from one of the plurality of second fan-out lines to the plurality of lead lines, and a scan driver generating a scan signal based on a scan control signal received from the pad portion.

According to some embodiments, the plurality of lead lines may extend from the demultiplexer to the second display area, may overlap the plurality of load matching units, and may be electrically connected to the plurality of data lines and the load matching unit through a contact portion.

According to some embodiments, the second display area may further comprise a plurality of gate lines crossing the plurality of data lines. According to some embodiments, the plurality of lead lines may supply the scan signal, which is received from the scan driver, to the plurality of gate lines of the second display area.

According to some embodiments, the display device may further comprise a third non-display area adjacent to the second display area and the second non-display area, including a third circuit part.

According to some embodiments, the third circuit part may comprise a scan driver generating a scan signal based on a scan control signal received from the pad portion, and an antistatic circuit removing static electricity flowing from the outside.

According to some embodiments, the third circuit part may comprise a plurality of scan drivers generating a scan signal based on a scan control signal received from the pad portion, an antistatic circuit removing static electricity flowing from the outside, and a plurality of load matching units connected to the plurality of data lines of the second display area.

According to some embodiments, the plurality of load matching units may be between the plurality of scan drivers.

According to some embodiments, a display device comprises a first display area including a plurality of data lines extending in a first direction, a second display area at one side of the first display area, comprising a plurality of data lines extending in the first direction, the second display area having a width smaller than a width of the first display area in the first direction, and a non-display area surrounding the first and second display areas. According to some embodiments, the non-display area comprises a plurality of load matching units including a plurality of compensation capacitors respectively connected to the plurality of data lines of the second display area.

According to some embodiments, the second display area may comprise a plurality of data lines having lengths different from each other. According to some embodiments, each of the plurality of load matching units may include the number of compensation capacitors, which is different depending on the length of the data line of the second display area.

According to some embodiments, the second display area may further comprise a driving voltage line extending in parallel with the data line. According to some embodiments, each of the plurality of compensation capacitors may include a first capacitor electrode electrically connected to the data line, and a second capacitor electrode electrically connected to the driving voltage line.

According to some embodiments, a display device comprises a first display area including a plurality of data lines extending in a first direction, a second display area at one side of the first display area, comprising a plurality of data lines shorter than the data lines of the first display area, a first non-display area adjacent to the first display area, comprising a first circuit part, a second non-display area adjacent to the second display area, comprising a second circuit part and a plurality of load matching units between the second circuit part and the second display area and connected to each of the plurality of data lines of the second display area, and a third non-display area adjacent to the second display area and the second non-display area, comprising a third circuit part.

According to some embodiments, the first non-display area may further comprise a pad portion and a plurality of first fan-out lines connected between the pad portion and the first circuit part. According to some embodiments, the second non-display area may further comprise a plurality of second fan-out lines connected to the pad portion, and a plurality of lead lines connected between the second circuit part and the second display area to overlap the plurality of load matching units.

According to some embodiments, the second circuit part may comprise a demultiplexer outputting a data voltage received from one of the plurality of second fan-out lines to the plurality of lead lines, and a scan driver generating a scan signal based on a scan control signal received from the pad portion.

According to some embodiments, a display device includes a load matching unit having load capacitance different depending on a length of a data line in a display panel having a shape of an atypical polygon or an asymmetrical polygon, thereby relatively uniformly maintaining load capacitance connected to data lines of a display area to relatively uniformly maintain luminance of the display panel.

The characteristics of embodiments according to the present disclosure are not limited to those mentioned above and more various characteristics are included in the following description of the present disclosure.

### BRIEF DESCRIPTION OF THE DRAWINGS

The above and other aspects and characteristics of embodiments according to the present disclosure will become more apparent by describing in more detail aspects of some embodiments thereof with reference to the attached drawings, in which:

FIG. 1 is a plan view illustrating a display device according to some embodiments;

FIG. 2 is a plan view illustrating a display panel of a display device according to some embodiments;

FIG. 3 is a plan view illustrating a portion of a display device according to some embodiments;

FIG. 4 is an enlarged view illustrating a portion of a second non-display area in a display device according to some embodiments;

FIG. 5 is a view illustrating a load matching unit of a partial area of a second non-display area in a display device according to some embodiments;

FIG. 6 is a view illustrating a load matching unit of another partial area of a second non-display area in a display device according to some embodiments;

FIG. 7 is an enlarged view illustrating a portion of a third non-display area in a display device according to some embodiments;

FIG. 8 is an enlarged view illustrating a portion of a third non-display area in a display device according to some embodiments;

FIG. 9 is a circuit view illustrating a pixel of a display device according to some embodiments; and

FIG. 10 is a cross-sectional view illustrating a pixel of a display device according to some embodiments.

### DETAILED DESCRIPTION

In the following description, for the purposes of explanation, numerous specific details are set forth in order to provide a thorough understanding of various embodiments or implementations of the disclosure. As used herein “embodiments” and “implementations” are interchangeable words that are non-limiting examples of devices or methods employing one or more of the disclosure disclosed herein. It is apparent, however, that various embodiments may be practiced without these specific details or with one or more equivalent arrangements. In other instances, structures and devices are shown in block diagram form in order to avoid unnecessarily obscuring various embodiments. Further, various embodiments may be different, but do not have to be exclusive nor limit the disclosure. For example, specific shapes, configurations, and characteristics of an embodiment may be used or implemented in other embodiments without departing from the disclosure.

Unless otherwise specified, the illustrated embodiments are to be understood as providing features of varying detail of some ways in which the disclosure may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the disclosure.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements.

Further, the X-axis, the Y-axis, and the Z-axis are not limited to three axes of a rectangular coordinate system, and thus the X-, Y-, and Z- axes, and may be interpreted in a broader sense. For example, the X-axis, the Y-axis, and the Z-axis may be perpendicular to one another, or may represent different directions that are not perpendicular to one another.

For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, ZZ, or the like. As used herein, the term “and/or” includes any and all combinations of one or more of the associated listed items.

Although the terms “first,” “second,” and the like may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein should be interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature, and the shapes of these regions may not reflect actual shapes of regions of a device and, as such, are not necessarily intended to be limiting.

As customary in the field, some embodiments are described and illustrated in the accompanying drawings in terms of functional blocks, units, parts, and/or modules. Those skilled in the art will appreciate that these blocks, units, parts, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, parts, and/or modules being implemented by microprocessors or other similar hardware, they may be programmed and controlled using software (e.g., microcode) to perform various functions discussed herein and may optionally be driven by firmware and/or software. It is also contemplated that each block, unit, part, and/or module may be implemented by dedicated hardware, or as a combination of dedicated hardware to perform some functions and a processor (e.g., one or more programmed microprocessors and associated circuitry) to perform other functions. Also, each block, unit, part, and/or module of some embodiments may be physically separated into two or more interacting and discrete blocks, units, parts, and/or modules without departing from the scope of the disclosure. Further, the blocks, units, parts, and/or modules of some embodiments may be physically combined into more complex blocks, units, parts, and/or modules without departing from the scope of the disclosure.

Unless otherwise defined or implied herein, all terms (including technical and scientific terms) used herein have the same meaning as commonly understood by those skilled in the art to which this disclosure pertains. It will be further understood that terms, such as those defined in commonly used dictionaries, should be interpreted as having a meaning that is consistent with their meaning in the context of the relevant art and the disclosure, and should not be interpreted in an ideal or excessively formal sense unless clearly so defined herein.

Hereinafter, further details of some embodiments of the present disclosure is described with reference to the accompanying drawings.

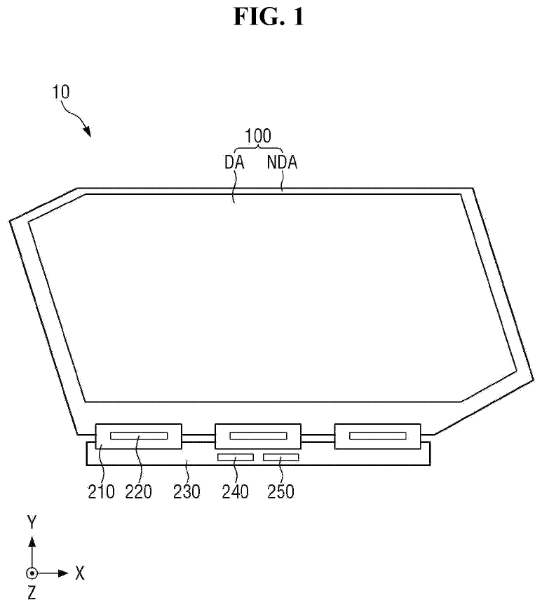

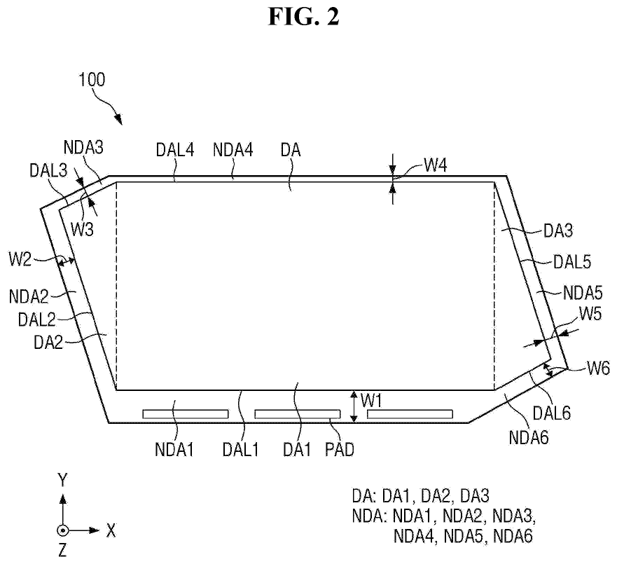

FIG. 1 is a plan view illustrating a display device according to some embodiments, and FIG. 2 is a plan view illustrating a display panel of a display device according to some embodiments.

In the present disclosure, “upper portion”, “top” and “upper surface” refer to an upward direction based on a display device 10, that is, Z-axis direction and “lower portion”, “bottom” and “lower surface” refer to a downward direction based on the display device 10, that is, an opposite direction of the Z-axis direction. Also, “left”, “right”, “upper” and “lower” refer to a direction when the display device 10 is viewed on a plane. For example, “left” refers to an opposite direction of X-axis direction, “right” refers to the X-axis direction, “upper” refers to Y-axis direction and “lower” refers to an opposite direction of the Y-axis direction.

Referring to FIGS. 1 and 2, the display device 10 is a device that displays moving images (e.g., video) or still (e.g., static) images, and may be used as a display screen of various products such as a television, a laptop computer, a monitor, a billboard, or a device for Internet of things (IoT).

The display device 10 may include a display panel 100, a flexible film 210, a display driver 220, a circuit board 230, a timing controller 240 and a power supply unit 250.

The display panel 100 may have a shape of an atypical polygon or an asymmetrical polygon on a plane (e.g., in a plan view, or in a view from a direction perpendicular or normal with respect to a display surface of the display panel 100). For example, the display panel 100 may include a plurality of sides, and a length of at least one of the plurality of sides may be different from that of another side. A size of at least one of a plurality of inner angles formed by adjacent sides of the display panel 100 may be different from that of another inner angle. A corner where adjacent sides of the display panel 100 meet may be formed to have an angle (e.g., a set or predetermined angle) or a curvature (e.g., a set or predetermined curvature). In FIGS. 1 and 2, the display panel 100 may have an atypical hexagonal shape, but the shape of the display panel 100 is not limited thereto.

The display panel 100 may include a display area DA and a non-display area NDA.

The display area DA is an area for displaying images, and may be defined as a central area of the display panel 100. The display area DA may include a plurality of pixels, a plurality of data lines, a plurality of gate lines and one or more voltage lines. The pixel may be defined as an area of a minimum unit for outputting light. The data lines, the gate lines, and the voltage lines may be connected to the pixels to supply data voltages, scan signals, and/or power voltages. The power voltages may include at least one of a driving voltage, a low potential voltage, an initialization voltage, a reference voltage, or a bias voltage.

The display area DA may include first to third display areas DA1, DA2, and DA3. The second display area DA2 may be located at a left side of the first display area DA1, and the third display area DA3 may be located at a right side of the first display area DA1. The first to third display areas DA1 to DA3 may have their respective shapes and sizes different from one another. A length of the first display area DA1 in a first direction (X-axis direction) may be longer than that of the second or third display area DA2 or DA3 in the first direction (X-axis direction). A width of the first display area DA1 in a second direction (Y-axis direction) may be greater than that of the second display area DA2 in the second direction (Y-axis direction) except for a boundary portion of the first and second display areas DA1 and DA2. A width of the first display area DA1 in the second direction (Y-axis direction) may be greater than that of the third display area DA3 except for a boundary portion of the first and third display areas DA1 and DA3. Each of the second and third display areas DA2 and DA3 may have a width in the first direction (X-axis direction) or a width in the second direction (Y-axis direction), which is different depending on a position. For example, the width of the second display area DA2 in the second direction (Y-axis direction) may be reduced toward the left side, and the width of the third display area DA3 in the second direction (Y-axis direction) may be reduced toward the right side.

The display area DA may include first to sixth sides DAL1, DAL2, DAL3, DAL4, DAL5 and DAL6. A length of at least one of the first to sixth sides DAL1, DAL2, DAL3, DAL4, DAL5, or DAL6 may be different from that of another side. The length of the first side DAL1 may be longer than that of the second side DAL2, and the length of the second side DAL2 may be longer than that of the third side DAL3. The length of the fourth side DAL4 may be longer than that of the fifth side DAL5, and the length of the fifth side DAL5 may be longer than that of the sixth side DALE. In FIGS. 1 and 2, the lengths of the first and fourth sides DAL1 and DAL4 may be substantially the same as each other, but embodiments according to the present disclosure are not limited thereto.

The non-display area NDA may be defined as a remaining area except the display area DA (e.g., in a periphery or outside a footprint of the display area DA) in the display panel 100. For example, the non-display area NDA may include a fan-out line connecting the display area DA with the display driver 220, and a pad portion PAD connected to the flexible film 210.

The non-display area NDA may include first to sixth non-display areas NDA1, NDA2, NDA3, NDA4, NDA5 and NDA6. The first to sixth non-display areas NDA1, NDA2, NDA3, NDA4, NDA5 and NDA6 may have their respective shapes and sizes different from one another. A width of at least one of the first to sixth non-display areas NDA1, NDA2, NDA3, NDA4, NDA5, or NDA6 may be different from that of another non-display area. The first non-display area NDA1 may include a pad portion PAD, a fan-out line, and a circuit part, and a first width W1 of the first non-display area NDA1 may be greater than a second width W2 of the second non-display area NDA2, a third width W3 of the third non-display area NDA3, a fourth width W4 of the fourth non-display area NDA4, a fifth width W5 of the fifth non-display area NDA5 or a sixth width W6 of the sixth non-display area NDA6.

The second non-display area NDA2 may include a fan-out line, a circuit part, and a load matching unit, the fifth non-display area NDA5 may include a circuit part and a load matching unit, and the sixth non-display area NDA6 may include a fan-out line and a circuit part. The second width W2 of the second non-display area NDA2, the fifth width W5 of the fifth non-display area NDA5 or the sixth width W6 of the sixth non-display area NDA6 may be greater than the third width W3 of the third non-display area NDA3 or the fourth width W4 of the fourth non-display area NDA4.

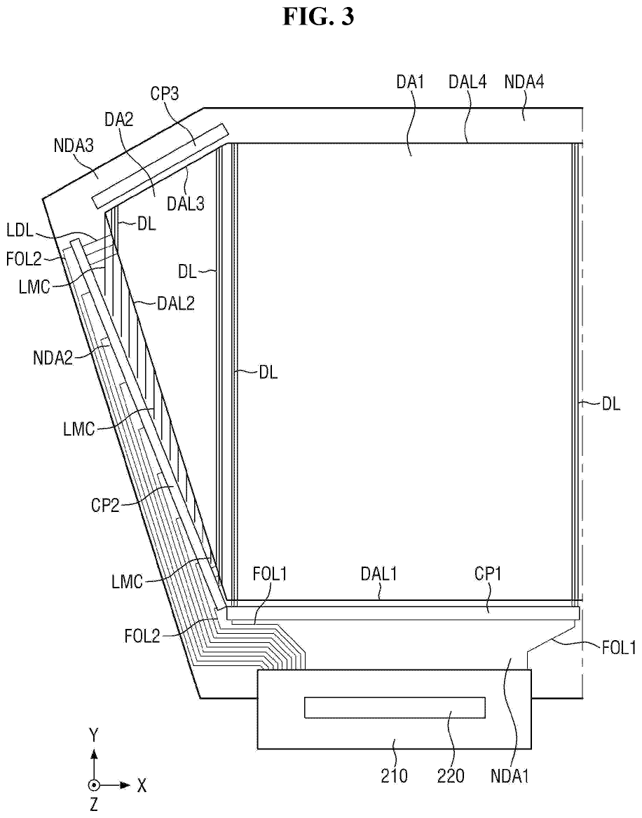

The third non-display area NDA3 may include a circuit part, and the third width W3 of the third non-display area NDA3 may be greater than the fourth width W4 of the fourth non-display area NDA4. The fan-out line, the circuit part and the load matching unit will be described in detail with reference to FIGS. 3 to 8.

Input terminals provided at one side of the flexible film 210 may be attached to the circuit board 230 by a film attachment process, and output terminals provided at the other side of the flexible film 210 may be attached to the pad portion PAD of the display panel 100 by the film attachment process. For example, the flexible film 210 may be bent like a tape carrier package or a chip on film. The flexible film 210 may be bent toward a lower portion of the display panel 100 to reduce a bezel area of the display device 10.

The display driver 220 may be packaged on the flexible film 210. For example, the display driver 220 may be implemented as an integrated circuit (IC). The display driver 220 may receive digital video data and a data control signal from the timing controller 240, convert the digital video data into an analog data voltage in accordance with the data control signal and supply the analog data voltage to the data line through the fan-out line. The display driver 220 may supply a scan control signal supplied from the timing controller 240 to the scan driver. The display device 10 includes a display driver 220 located in the first non-display area NDA1, thereby minimizing or reducing the sizes of the second to sixth non-display areas NDA2, NDA3, NDA4, NDA5 and NDA6.

The circuit board 230 may support the timing controller 240 and the power supply unit 250 and supply a signal and a power source to the display driver 220. For example, the circuit board 230 may supply a signal supplied from the timing controller and a power voltage supplied from the power supply unit 250 to the display driver to display an image (or a portion of an image) on each pixel. To this end, a signal transmission line and a power line may be provided on the circuit board 230.

The timing controller 240 may be packaged on the circuit board 230, and may receive image data and a timing synchronization signal, which are supplied from a display driving system or a graphic device, through a user connector provided on the circuit board 230. The timing controller 240 may generate digital video data by aligning image data to be suitable for a pixel arrangement structure based on the timing synchronization signal, and may supply the generated digital video data to the display driver 220. The timing controller 240 may generate a data control signal and a scan control signal based on the timing synchronization signal. The timing controller 240 may control a supply timing of a data voltage of the display driver 220 based on the data control signal, and may control the supply timing of the scan signal of the scan driver based on the scan control signal.

The power supply unit 250 may be located on the circuit board 230 to supply the power voltage to the display driver 220 and the display panel 100. For example, the power supply unit 250 may generate a driving voltage or a high potential voltage to supply the driving voltage or the high potential voltage to a driving voltage line, generate a low potential voltage to supply the low potential voltage to a low potential line and generate an initialization voltage to supply the initialization voltage to an initialization voltage line.

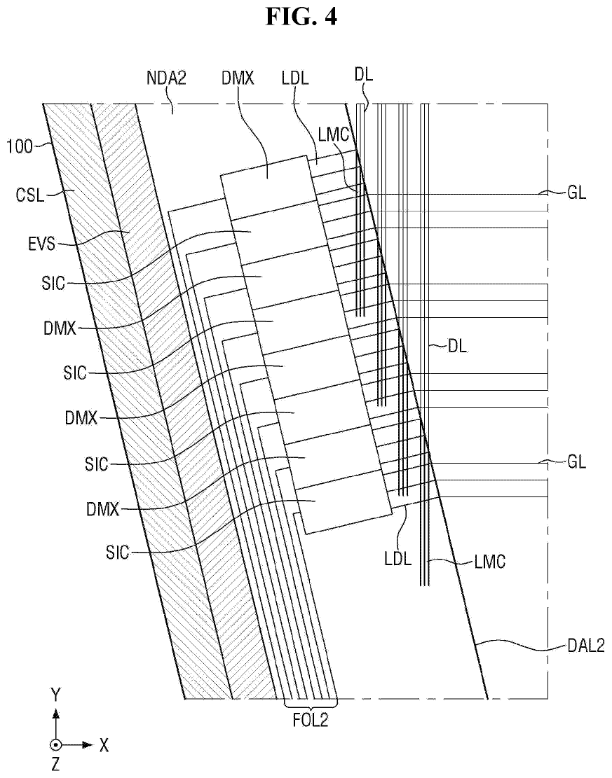

FIG. 3 is a plan view illustrating a portion of a display device according to some embodiments, and FIG. 4 is an enlarged view illustrating a portion of a second non-display area in a display device according to some embodiments.

Referring to FIGS. 3 and 4, the display area DA may include first to third display areas DA1, DA2 and DA3. The data line DL may extend in the second direction (Y-axis direction) in the display area DA, and may be spaced apart from each other in the first direction (X-axis direction). A length of the data line DL of the second display area DA2 may be shorter than that of the data line DL of the first display area DA1. The length of the data line DL of the second display area DA2 may vary depending on a position. For example, the length of the data line DL may be reduced as the data line DL is located at a left side of the second display area DA2.

The first non-display area NDA1 may include a pad portion PAD, a first fan-out line FOL1, and a first circuit part CP1. The pad portion PAD of the first non-display area NDA1 may be attached to the flexible film 210 to receive a signal and a power source from the flexible film 210.

The first fan-out line FOL1 may extend from the pad portion PAD to the first circuit part CP1. The first fan-out line FOL1 may supply the data voltage and the power voltage, which are received from the display driver 220, to the first circuit part CP1.

The first circuit part CP1 may include a demultiplexer and an antistatic circuit. The demultiplexer may sequentially supply the data voltage received from the first fan-out line to a plurality of data lines DL. The first circuit part CP1 may include a plurality of demultiplexers, thereby reducing the number of first fan-out lines FOL1 and reducing a size of the first non-display area NDA1.

The antistatic circuit may be arranged to be adjacent to the first fan-out line FOL1. A portion of the antistatic circuit may be connected between the first fan-out line FOL1 and a gate-off voltage line, and another portion of the antistatic circuit may be connected between the data line DL and a gate-on voltage line. Therefore, the first circuit part CP1 may include the antistatic circuit, thereby preventing or reducing instances of static electricity flowing into the display area DA by removing static electricity flowing from the outside.

The second non-display area NDA2 may include a second fan-out line FOL2, a second circuit part CP2, a lead line LDL, and a load matching unit (or load matching circuit) LMC.

The second fan-out line FOL2 may extend from the pad portion PAD to the second circuit part CP2. The second fan-out line FOL2 may extend to the second non-display area NDA2 via the first non-display area NDA1. The second fan-out line FOL2 may supply the data voltage and the power voltage, which are received from the display driver 220, to the second circuit part CP2. A lower side of the second non-display area NDA2 may be arranged to be adjacent (or relatively adjacent) to the flexible film 210, so that an arrangement area of the second fan-out line FOL2 may be relatively wide. An upper side of the second non-display area NDA2 may be arranged to be relatively far or spaced apart from the flexible film 210, so that an arrangement area of the second fan-out line FOL2 may be relatively small.

The second circuit part CP2 may be located between the second fan-out line FOL2 and the load matching unit LMC. A lower side of the second circuit part CP2 may be more adjacent to the display area DA than an edge of the display panel 100, and an upper side of the second circuit part CP2 may be more adjacent to (e.g., closer to) the edge of the display panel 100 than the display area DA. The second circuit part CP2 may include a demultiplexer DMX and a scan driver SIC. The demultiplexer DMX and the scan driver SIC may be alternately arranged, but embodiments according to the present disclosure are not limited thereto.

The demultiplexer DMX may output the data voltage, which is received from a single second fan-out line FOL2, to a plurality of lead lines LDL. The demultiplexer DMX may sequentially supply the data voltage, which is received from the second fan-out line FOL2, to the plurality of data lines DL through the lead line LDL. The second circuit part CP2 may include a plurality of demultiplexers DMX, thereby reducing the number of second fan-out lines FOL2 and reducing a size of the second non-display area NDA2.

The scan driver SIC may receive the scan control signal from the display driver 220. The scan control signal may include at least one of a control signal, a clock signal, a power signal, or a carry signal. The scan driver SIC may receive the scan control signal to generate the scan signal. The scan driver SIC may sequentially supply the scan signal to a plurality of gate lines GL through the lead line LDL.

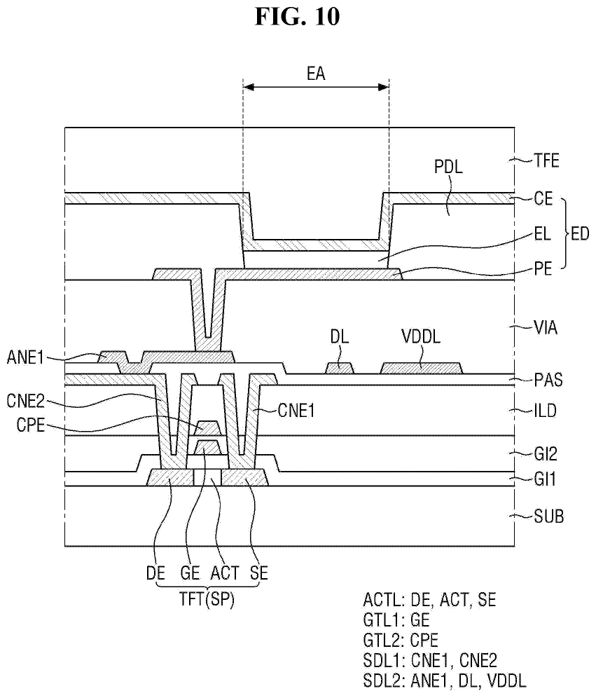

The lead line LDL may extend from the second circuit part CP2 to the second display area DA2. The lead line LDL may supply the data voltage, which is received from the demultiplexer DMX, to the plurality of data lines DL. The lead line LDL may supply the scan signal, which is received from the scan driver SIC, to the plurality of gate lines GL. The lead line LDL may overlap the load matching unit LMC. For example, the lead line LDL may be located in a second source metal layer SDL2 of FIG. 10, but embodiments according to the present disclosure are not limited thereto.

The load matching unit LMC may extend from the display area DA in an opposite direction of the second direction (Y-axis direction). A length of the data lines DL of the second display area DA2 may be shorter than that of the data lines DL of the first display area DA1. As the length of the data line DL becomes short, the number of pixels connected to the data line DL may be reduced, and load capacitance may be reduced. Load capacitance connected to the data line DL of the second display area DA2 may be smaller than that connected to the data line DL of the first display area DA1. The load matching unit LMC may include a plurality of compensation capacitors.

The load matching unit LMC may include a different number of compensation capacitors depending on the length of the data line DL connected thereto. The number of compensation capacitors may be proportional to a magnitude of the load capacitance. The plurality of compensation capacitors may be arranged in a line, and a length of the load matching unit LMC may be increased as the number of compensation capacitors is increased. The load matching unit LMC may be electrically connected to each of the data lines DL of the second display area DA2 to compensate for the load capacitance of the data line DL.

The data lines DL of the second display area DA2 may have different lengths depending on their positions. The data lines DL of the second display area DA2 arranged to be adjacent (or relatively adjacent) to the first display area DA1 may have a length that is relatively long, and the data lines DL of the second display area DA2 arranged to be relatively far or spaced apart from the first display area DA1 may have a length that is relatively short. For example, the length of the data line DL located at the right side of the second display area DA2 may be longer than that of the data line DL located at the left side of the second display area DA2. As the length of the data line DL becomes short, a magnitude of load capacitance that is required may be increased. Therefore, the load matching unit LMC located at the upper side of the second non-display area NDA2 may be connected to the data line DL located at the left side of the second display area DA2 to include a relatively large number of compensation capacitors, and the length of the load matching unit LMC may be relatively long. The load matching unit LMC located at the lower side of the second non-display area NDA2 may be connected to the data line DL located at the right side of the second display area DA2 to include a relatively small number of compensation capacitors, and the length of the load matching unit LMC may be relatively short. The length of the load matching unit LMC at the upper side of the second non-display area NDA2 may be longer than that of the load matching unit LMC located at the lower side of the second non-display area NDA2.

The display device 10 includes a load matching unit LMC having load capacitance different depending on the length of the data line DL, thereby relatively uniformly maintaining the load capacitance connected to the data line DL of each of the first and second display areas DA1 and DA2. Therefore, the display device 10 may relatively uniformly maintain luminance of the display panel 100 having a shape of an atypical polygonal shape or an asymmetrical polygon.

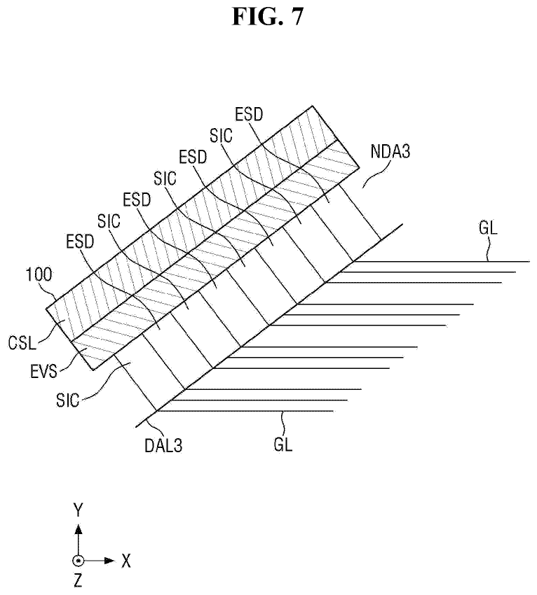

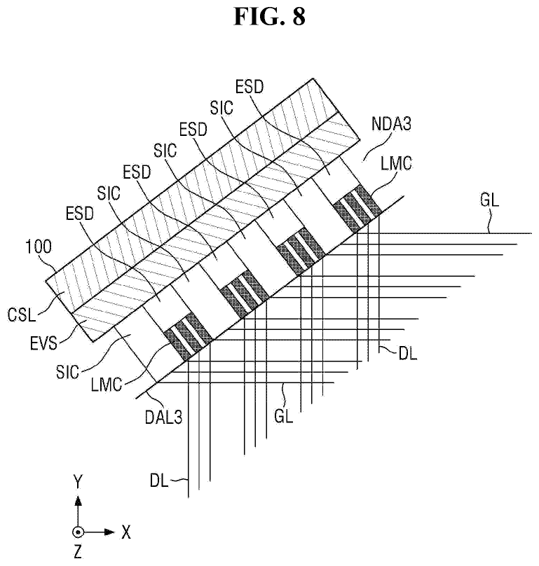

The third non-display area NDA3 may include a third circuit part CP3. The third circuit part CP3 will be described in detail with reference to FIGS. 7 and 8 below.

In FIG. 4, the non-display area NDA may include a sealing member CSL and a power electrode EVS. The sealing member CSL may be located at the outermost of the first to sixth non-display areas NDA1, NDA2, NDA3, NDA4, NDA5 and NDA6, thereby shielding the edge of the display panel 100. The power electrode EVS may be located inside the sealing member CSL in the first to sixth non-display areas NDA1, NDA2, NDA3, NDA4, NDA5 and NDA6. The power electrode EVS may have a voltage (e.g., a set or predetermined voltage), and may supply the voltage to the display panel 100. For example, the power electrode EVS may have a low potential voltage (e.g., a ground voltage), but embodiments according to the present disclosure are not limited thereto.

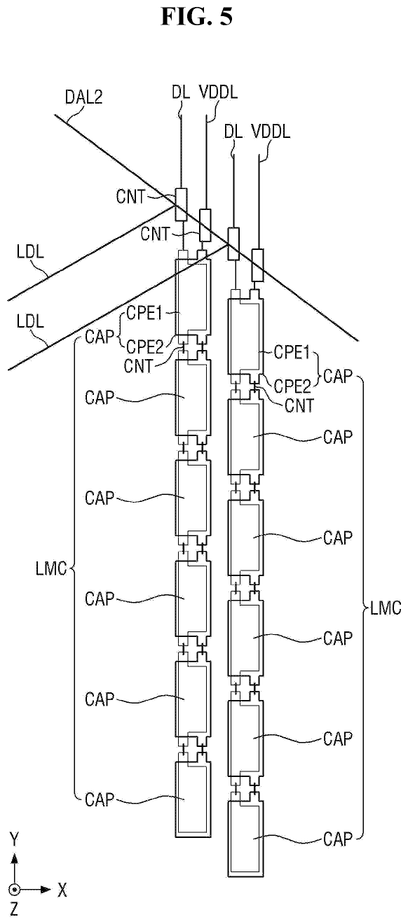

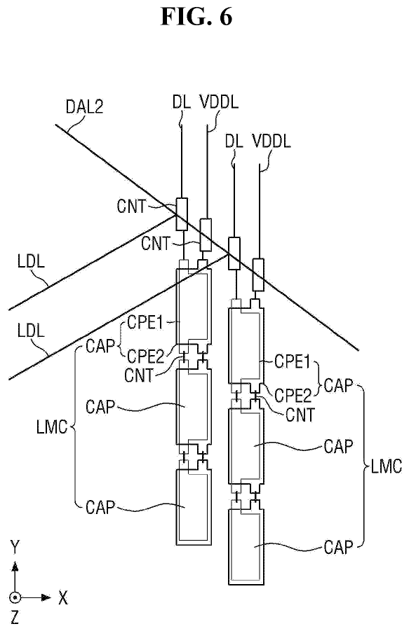

FIG. 5 is a view illustrating a load matching unit of a partial area of a second non-display area in a display device according to some embodiments, and FIG. 6 is a view illustrating a load matching unit (or load matching circuit or component) of another partial area of a second non-display area in a display device according to some embodiments.

Referring to FIGS. 5 and 6, the load matching unit LMC may include a plurality of compensation capacitors CAP. In this case, the number of compensation capacitors CAP is for convenience of description, and may be designed and changed according to various embodiments.

The load matching unit LMC of FIG. 5 may include a relatively larger number of compensation capacitors CAP than those of the load matching unit LMC of FIG. 6. The length of the load matching unit LMC of FIG. 5 may be longer than that of the load matching unit LMC of FIG. 6. For example, the load matching unit LMC of FIG. 5 may include six compensation capacitors CAP, and the load matching unit LMC of FIG. 6 may include three compensation capacitors CAP. The plurality of compensation capacitors CAP may substantially have the same load capacitance, and the number of compensation capacitors CAP may be proportional to the magnitude of the load capacitance. The length of the data line DL connected to the load matching unit LMC of FIG. 5 may be shorter than that of the data line DL connected to the load matching unit LMC of FIG. 6. Therefore, the load capacitance of the load matching unit LMC of FIG. 5 may be greater than that of the load matching unit LMC of FIG. 6. Referring to FIG. 5 and FIG. 6 in conjunction with FIG. 3, the load matching unit LMC of FIG. 5 may be located at a left side or an upper side as compared with the load matching unit LMC of FIG. 6.

The compensation capacitor CAP may include a first capacitor electrode CPE1 and a second capacitor electrode CPE2. The first and second capacitor electrodes CPE1 and CPE2 may overlap each other, and the compensation capacitor CAP may include predetermined load capacitance. The first capacitor electrode CPE1 may be electrically connected to the data line DL through a contact portion CNT. The lead line LDL may be electrically connected to the data line DL and the first capacitor electrode CPE1 through the contact portion CNT. The first capacitor electrodes CPE1 adjacent to each other in the second direction (Y-axis direction) may be electrically connected with each other through the contact portion CNT. The second capacitor electrode CPE2 may be electrically connected to the driving voltage line VDDL through the contact portion CNT. The second capacitor electrodes CPE2 adjacent to each other in the second direction (Y-axis direction) may be electrically connected with each other through the contact portion CNT. Therefore, a potential difference between the first and second capacitor electrodes CPE1 and CPE2 may correspond to a potential difference between the driving voltage line VDDL and the data line DL. The first capacitor electrode CPE1 may be located on a first gate layer GTL1 of FIG. 10, the second capacitor electrode CPE2 may be located on a second gate layer GTL2 of FIG. 10, and the data line DL and the driving voltage line VDDL may be located on a second source metal layer SDL2 of FIG. 10, but embodiments according to the present disclosure are not limited thereto.

The display device 10 may include the load matching unit LMC having load capacitance different depending on the length of the data line DL, thereby relatively uniformly maintaining load capacitance connected to the data line DL of each of the first and second display areas DA1 and DA2. Therefore, the display device 10 may relatively uniformly maintain luminance of the display panel 100 having a shape of an atypical polygon or an asymmetrical polygon.

FIG. 7 is an enlarged view illustrating a portion of a third non-display area in a display device according to some embodiments.

Referring to FIG. 7, the third non-display area NDA3 may include a third circuit part CP3. The third circuit part CP3 may be located between the power electrode EVS and the display area DA. The third circuit part CP3 may include a scan driver SIC and an antistatic circuit ESD. The third non-display area NDA3 may not include the load matching unit LMC between the third circuit part CP3 and the display area DA, and the third circuit part CP3 may be arranged to be adjacent to the display area DA. Referring to FIG. 7 in conjunction with FIGS. 2 and 4, since the third non-display area NDA3 does not include the demultiplexer DMX and the load matching unit LMC, the third width W3 of the third non-display area NDA3 may be smaller than the second width W2 of the second non-display area NDA2.

The scan driver SIC may receive the scan control signal from the display driver 220. The scan control signal may include at least one of the control signal, the clock signal, the power signal, or the carry signal. The scan driver SIC may generate the scan signal by receiving the scan control signal. The scan driver SIC may sequentially supply the scan signal to the plurality of gate lines GL.

The antistatic circuit ESD and the scan driver SIC may be alternately arranged, but embodiments according to the present disclosure are not limited thereto. The antistatic circuit ESD may prevent or reduce instances of static electricity flowing into the display area DA by removing static electricity flowing from the outside.

FIG. 8 is an enlarged view illustrating a portion of a third non-display area in a display device according to some embodiments. The display device of FIG. 8 further includes a load matching unit LMC in the display device of FIG. 7. The same elements as those described with reference to FIG. 7 will be briefly described or omitted.

Referring to FIG. 8, the third circuit part CP3 may include a scan driver SIC, an antistatic circuit ESD, and a load matching unit LMC.

The load matching unit LMC may be located between the scan drivers SIC.

The load matching unit LMC may be located between the antistatic circuit ESD and the display area DA. The load matching unit LMC may be electrically connected to each of the data lines DL of the second display area DA2 to compensate for load capacitance of the data line DL. In this case, the load matching unit LMC may be separately located in the second and third non-display areas NDA2 and NDA3, and may improve the degree of freedom in design of the non-display area NDA. The load matching unit LMC of FIG. 8 may be located in a partial area in which the antistatic circuit ESD of FIG. 7 is located, and thus may not affect the size of the third circuit part CP3. Therefore, the third non-display area NDA3 may not provide a separate space for the load matching unit LMC, and the third circuit part CP3 may be arranged to be adjacent to the display area DA. Referring to FIG. 8 in conjunction with FIGS. 2 and 4, the third non-display area NDA3 does not include the demultiplexer DMX and the load matching unit LMC is located between the scan drivers SIC, so that the third width W3 of the third non-display area NDA3 may be smaller than the second width W2 of the second non-display area NDA2.

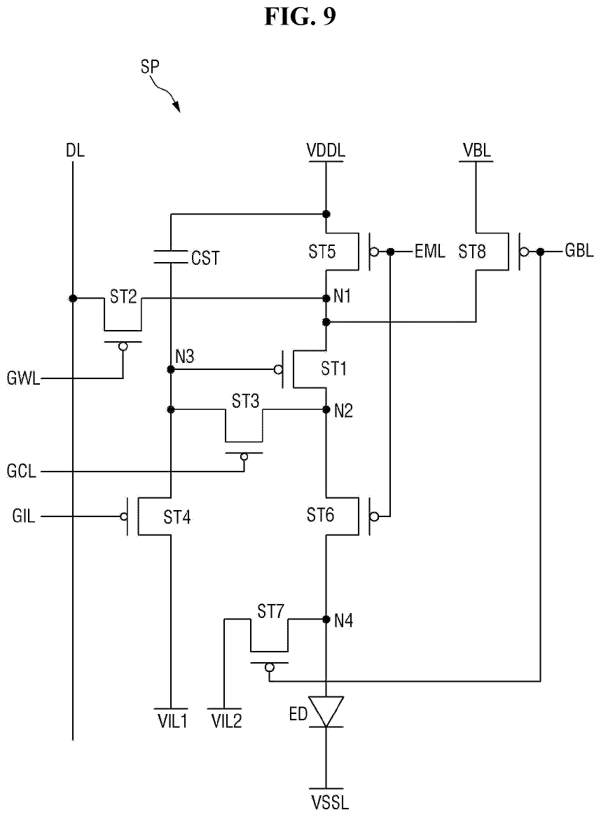

FIG. 9 is a circuit view illustrating a pixel of a display device according to some embodiments.

Referring to FIG. 9, the display area DA may include a plurality of pixels SP. Each of the plurality of pixels SP may be connected to a first gate line GWL, a second gate line GCL, a third gate line GIL, a fourth gate line GBL, a light emission control line EML, a data line DL, a driving voltage line VDDL, a first initialization voltage line VIL1, a second initialization voltage line VIL2, and a bias voltage line VBL.

The pixel SP may include a pixel circuit and a light emitting element ED. The pixel circuit may include first to eighth transistors ST1, ST2, ST3, ST4, ST5, ST6, ST7 and ST8, and a storage capacitor CST. The configuration of the pixel circuit is not limited to the embodiments illustrated and described with respect to FIG. 9, and may be designed and changed depending on the configuration of the display panel 100.

The first transistor ST1 may include a gate electrode, a source electrode and a drain electrode. The first transistor ST1 may control a source-drain current Isd (hereinafter, referred to as “driving current”) in accordance with a data voltage applied to the gate electrode. The driving current Isd flowing through a channel of the first transistor ST1 may be proportional to a square of a difference between a voltage Vsg between the source electrode and the gate electrode of the first transistor ST1 and a threshold voltage Vth (Isd=k×(Vsg−Vth)²). In this case, k denotes a proportional coefficient determined by a structure and physical characteristics of the first transistor ST1, Vsg denotes a source-gate voltage of the first transistor ST1, and Vth denotes the threshold voltage of the first transistor ST1.

The light emitting element ED may emit light by receiving the driving current. The light emitting amount or luminance of the light emitting element ED may be proportional to a magnitude of the driving current.

The light emitting element ED may be an organic light emitting diode that includes a first electrode, a second electrode and an organic light emitting layer located between the first electrode and the second electrode. Otherwise, the light emitting element ED may be an inorganic light emitting element that includes a first electrode, a second electrode and an inorganic semiconductor located between the first electrode and the second electrode. Otherwise, the light emitting element ED may be a quantum dot light emitting element that includes a first electrode, a second electrode and a quantum dot light emitting layer located between the first electrode and the second electrode. Otherwise, the light emitting element ED may be a micro light emitting diode.

The first electrode of the light emitting element ED may be connected to a fourth node N4. The first electrode of the light emitting element ED may be connected to a drain electrode of the sixth transistor ST6 and a drain electrode of the seventh transistor ST7 through the fourth node N4. The second electrode of the light emitting element ED may be connected to a low potential line VSSL.

The second transistor ST2 may be turned on by a first gate signal of the first gate line GWL to electrically connect the data line DL with a first node N1 that is a source electrode of the first transistor ST1. The second transistor ST2 may be turned on based on the first gate signal to supply a data voltage to the first node N1. A gate electrode of the second transistor ST2 may be connected to the first gate line GWL, its source electrode may be connected to the data line DL, and its drain electrode may be connected to the first node N1.

The third transistor ST3 may be turned on by a second gate signal of the second gate line GCL to electrically connect a second node N2, which is the drain electrode of the first transistor ST1, with a third node N3 that is the gate electrode of the first transistor ST1. A gate electrode of the third transistor ST3 may be connected to the second gate line GCL, its source electrode may be connected to the second node N2, and its drain electrode may be connected to the third node N3.

The fourth transistor ST4 may be turned on by a third gate signal of the second gate line GIL to electrically connect the first initialization voltage line VIL1 with the third node N3 that is the gate electrode of the first transistor ST1. The fourth transistor ST4 may be turned on based on the third gate signal to discharge the gate electrode of the first transistor ST1 with a first initialization voltage. A gate electrode of the fourth second transistor ST4 may be connected to the third gate line GIL, its source electrode may be connected to the third node N2, and its drain electrode may be connected to the first initialization voltage line VIL1.

The fifth transistor ST5 may be turned on by a light emission signal of the light emission control line EML to electrically connect the driving voltage line VDDL with the first node N1 that is the source electrode of the first transistor ST1. A gate electrode of the fifth transistor ST5 may be connected to the light emission control line EML, its source electrode may be connected to the driving voltage line VDDL, and its drain electrode may be connected to the first node N1.

The sixth transistor ST6 may be turned on by the light emission signal of the light emission control line EML to electrically connect the second node N2, which is the drain electrode of the first transistor ST1, with the fourth node N4 that is the first electrode of the light emitting element ED. A gate electrode of the sixth transistor ST6 may be connected to the light emission control line EML, its source electrode may be connected to the second node N2, and its drain electrode may be connected to the fourth node N4.

When the fifth transistor ST5, the first transistor ST1 and the sixth transistor ST6 are all turned on, the driving current may be supplied to the light emitting element ED.

The seventh transistor ST7 may be turned on by a fourth gate signal of the fourth gate line GBL to electrically connect the second initialization voltage line VIL2 with the fourth node N4 that is the first electrode of the light emitting element ED. The seventh transistor ST7 may be turned on based on the fourth gate signal to discharge the first electrode of the light emitting element ED with a second initialization voltage. A gate electrode of the seventh transistor ST7 may be connected to the fourth gate line GBL, its source electrode may be connected to the fourth node N4, and its drain electrode may be connected to the second initialization voltage line VIL2.

The eighth transistor ST8 may be turned on by the fourth gate signal of the fourth gate line GBL to electrically connect the bias voltage line VBL with the first node N1 that is the source electrode of the first transistor ST1. The eighth transistor ST8 may be turned on based on the fourth gate signal to supply a bias voltage to the first node N1. The eighth transistor ST8 may supply the bias voltage to the source electrode of the first transistor ST1 to improve hysteresis of the first transistor ST1. A gate electrode of the eighth transistor ST8 may be connected to the fourth gate line GBL, its source electrode may be connected to the bias voltage line VBL, and its drain electrode may be connected to the first node N1.

Each of the first to eighth transistors ST1, ST2, ST3, ST4, ST5, ST6, ST7 and ST8 may include a silicon-based active layer. For example, each of the first to eighth transistors ST1, ST2, ST3, ST4, ST5, ST6, ST7 and ST8 may include an active layer made of low temperature polycrystalline silicon (LTPS). The active layer made of low temperature polycrystalline silicon may have high electron mobility and excellent turn-on characteristics. Therefore, the display device 10 includes first to eighth transistors ST1, ST2, ST3, ST4, ST5, ST6, ST7 and ST8 having excellent turn-on characteristics, thereby relatively stably and relatively efficiently driving the plurality of pixels.

Each of the first to eighth transistors ST1, ST2, ST3, ST4, ST5, ST6, ST7 and ST8 may correspond to a p-type transistor. For example, each of the first to eighth transistors ST1, ST2, ST3, ST4, ST5, ST6, ST7 and ST8 may output a current flowing into the source electrode to the drain electrode based on a gate low voltage applied to the gate electrode.

As another example, at least one of the first to eighth transistors ST1, ST2, ST3, ST4, ST5, ST6, ST7 or ST8 may include an oxide-based active layer. For example, the at least one transistor may have a coplanar structure in which a gate electrode is located on an oxide-based active layer. The transistor having the coplanar structure has excellent off-current characteristics and enables low frequency driving, thereby reducing power consumption. Therefore, the display device 10 includes at least one transistor having excellent off-current characteristics, thereby preventing or reducing instances of a leakage current flowing into the pixel and relatively stably maintaining a voltage inside the pixel.

At least one of first to eighth transistors ST1, ST2, ST3, ST4, ST5, ST6, ST7 or ST8 may correspond to an n-type transistor. For example, the n-type transistor may output a current flowing into the drain electrode to the source electrode based on a gate high voltage applied to the gate electrode.

The storage capacitor CST may be connected between the third node N3, which is the gate electrode of the first transistor ST1, and the driving voltage line VDDL. For example, a first electrode of the storage capacitor CST may be connected to the third node N3, and a second electrode of the storage capacitor CST may be connected to the driving voltage line VDDL, so that a potential difference between the driving voltage line VDDL and the gate electrode of the first transistor ST1 may be maintained.

FIG. 10 is a cross-sectional view illustrating a pixel of a display device according to some embodiments.

Referring to FIG. 10, the display panel 100 may include a substrate SUB, an active layer ACTL, a first gate insulating layer GI1, a first gate layer GTL1, a second gate insulating layer GI2, a second gate layer GTL2, an interlayer insulating layer ILD, a first source metal layer SDL1, a passivation layer PAS, a second source metal layer SDL2, a via layer VIA, a light emitting element ED, a pixel defining layer PDL, and an encapsulation layer TFE.

The substrate SUB may be a base substrate or a base member, and may be made of an insulating material such as a polymer resin. The substrate SUB may be a flexible substrate capable of being subjected to bending, folding, rolling or the like. For example, the substrate SUB may include a glass material or a metal material, but is not limited thereto. For another example, the substrate SUB may include polyimide (P1).

The active layer ACTL may be located on the substrate SUB. The active layer ACTL may include a silicon-based active layer or an oxide-based active layer.

A thin film transistor TFT may include a semiconductor area ACT, a source electrode SE, a drain electrode DE and a gate electrode GE. The thin film transistor TFT may include a pixel circuit of each of a plurality of pixels SP. For example, the thin film transistor TFT may be a transistor of the pixel circuit. The semiconductor area ACT, the source electrode SE and the drain electrode DE of the thin film transistor TFT may be located on the active layer ACTL. The semiconductor area ACT may overlap the gate electrode GE in a thickness direction, and may be insulated from the gate electrode GE by the first gate insulating layer GI1. The source electrode SE and the drain electrode DE may be provided by conductorizing a material of the semiconductor area ACT.

The first gate insulating layer Gil may be located on the active layer ACTL. For example, the first gate insulating layer Gil may cover the active layer ACTL and the substrate SUB, and may insulate the semiconductor area ACT from the gate electrode GE. The first gate insulating layer Gil may include a contact hole through which the first and second connection electrodes CNE1 and CNE2 pass.

The first gate layer GTL1 may be located on the first gate insulating layer GI1. The first gate layer GTL1 may include the gate electrode GE of the thin film transistor TFT. The gate electrode GE may overlap the semiconductor area ACT with the first gate insulating layer Gil interposed therebetween.

The second gate insulating layer GI2 may be located on the first gate layer GTL1. For example, the second gate insulating layer GI2 may cover the first gate layer GTL1 and the first gate insulating layer GI1, and may insulate the gate electrode GE from the capacitor electrode CPE. The second gate insulating layer GI2 may include a contact hole through which the first and second connection electrodes CNE1 and CNE2 pass.

The second gate layer GTL2 may be located on the second gate insulating layer GI2. The second gate layer GTL2 may include a capacitor electrode CPE. The capacitor electrode CPE may overlap the gate electrode GE with the second gate insulating layer GI2 interposed therebetween, and capacitance may be formed between the gate electrode GE and the capacitor electrode CPE.

The interlayer insulating layer ILD may cover the second gate layer GTL2 and the second gate insulating layer GI2. The interlayer insulating layer ILD may insulate the second gate layer GTL2 from the first source metal layer SDL1. The interlayer insulating layer ILD may include a contact hole through which the first and second connection electrodes CNE1 and CNE2 pass.

The first source metal layer SDL1 may be located on the interlayer insulating layer ILD. The first source metal layer SDL1 may include the first and second connection electrodes CNE1 and CNE2. The first connection electrode CNE1 may be connected to the source electrode SE of the thin film transistor TFT. The first connection electrode CNE1 may be inserted into a contact hole provided in the interlayer insulating layer ILD, the second gate insulating layer GI2 and the first gate insulating layer Gil to contact the source electrode SE of the thin film transistor TFT.

The second connection electrode CNE2 may be spaced apart from the first connection electrode CNE1 on the interlayer insulating layer ILD. The second connection electrode CNE2 may electrically connect the drain electrode DE of the thin film transistor TFT with a first anode connection electrode ANE1. The second connection electrode CNE2 may be inserted into the contact hole provided in the interlayer insulating layer ILD, the second gate insulating layer GI2 and the first gate insulating layer Gil to contact the drain electrode DE of the thin film transistor TFT.

The passivation layer PAS may cover the first source metal layer SDL1 and the interlayer insulating layer ILD. The passivation layer PAS may protect the thin film transistor TFT. The passivation layer PAS may include a contact hole through which the first anode connection electrode ANE1 passes.

The second source metal layer SDL2 may be located on the passivation layer PAS. The second source metal layer SDL2 may include a first anode connection electrode ANE1, a data line DL and a driving voltage line VDDL. The first anode connection electrode ANE1 may electrically connect the second connection electrode CNE2 with a pixel electrode PE of the light emitting element ED. The first anode connection electrode ANE1 may be inserted into a contact hole provided in the passivation layer PAS to contact the second connection electrode CNE2.

The data line DL may be arranged to be spaced apart from the first anode connection electrode ANE1. The data line DL may be electrically connected with the thin film transistor TFT of the pixel SP. The data line DL may supply a data voltage to each of the plurality of pixels SP.

The driving voltage line VDDL may be arranged to be spaced apart from the first anode connection electrode ANE1 and the data line DL. The driving voltage line VDDL may be electrically connected to the thin film transistor TFT of the pixel SP. The driving voltage line VDDL may supply a high potential voltage or a driving voltage to each of the plurality of pixels SP.

The via layer VIA may be located on the second source metal layer SDL2. The via layer VIA may planarize an upper end of the thin film transistor layer. For example, the via layer VIA may include a contact hole through which the pixel electrode PE of the light emitting element ED passes. For example, the via layer VIA may include an organic material.

The light emitting element ED may be located on the via layer VIA. The light emitting element ED of the pixel SP may include a pixel electrode PE, a light emitting layer EL, and a common electrode CE. The light emitting element ED of the second pixel SP2 may include a second pixel electrode PE2, a light emitting layer EL, and a common electrode CE.

The pixel electrode PE may be located on the via layer VIA. The pixel electrode PE may overlap a light emission area EA defined by the pixel defining layer PDL. The pixel electrode PE may be electrically connected to the drain electrode DE of the thin film transistor TFT through the first anode connection electrode ANE1 and the second connection electrode CNE2.

The light emitting layer EL may be located on the pixel electrode PE. For example, the light emitting layer EL may be an organic light emitting layer made of an organic material, but embodiments according to the present disclosure are not limited thereto. When the light emitting layer EL corresponds to the organic light emitting layer, and when the thin film transistor TFT applies a voltage (e.g., a set or predetermined voltage) to the pixel electrode PE and the common electrode CE receives a common voltage or a cathode voltage, holes and electrons may move to the organic light emitting layer EL through a hole transport layer and an electron transport layer, respectively, and the holes and the electrons may be combined with each other in the organic light emitting layer EL to emit light.

The common electrode CE may be located on the light emitting layer EL. For example, the common electrode CE may be implemented in the form of an electrode that is common to the entire pixels SP without being distinguished for each of the plurality of pixels SP. The common electrode CE may be located on the light emitting layer EL in the light emission area EA, and may be located on the pixel defining layer PDL in an area except the light emission area EA. The common electrode CE may receive a common voltage or a low potential voltage.

The pixel defining layer PDL may define the light emission area EA. The pixel defining layer PDL may separate and insulate the plurality of pixel electrodes PE from each other.

The encapsulation layer TFE may be located on the common electrode CE to cover the plurality of light emitting elements ED. The encapsulation layer TFE may includes at least one inorganic film to prevent or reduce instances of oxygen, moisture, or contaminants permeating into the plurality of light emitting elements ED. The encapsulation layer TFE may include at least one organic film to protect the plurality of light emitting elements ED from contaminants or particles such as dust.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims, and their equivalents.

What is claimed is:

1. A display device comprising:
a first display area including a plurality of data lines extending in a first direction;
a second display area at one side of the first display area, comprising a plurality of data lines shorter than the data lines of the first display area;
a first non-display area adjacent to the first display area; and
a second non-display area adjacent to the second display area, comprising a plurality of load matching units respectively connected to the plurality of data lines of the second display area and configured to compensate for load capacitance of the plurality of data lines of the second display area.

2. The display device of claim 1, wherein the second display area comprises a plurality of data lines having lengths different from each other, and
the second non-display area comprises a plurality of load matching units having different lengths corresponding to the lengths of the data lines of the second display area.

3. The display device of claim 2, wherein, as a length of a data line from among the data lines becomes short, a length of the load matching unit is increased, and as the length of the load matching unit is increased, a load capacitance of the load matching unit is increased.

4. The display device of claim 2, wherein the load matching unit includes a plurality of compensation capacitors arranged in a line, and a length of the load matching unit is proportional to a number of the compensation capacitors.

5. The display device of claim 4, wherein the second display area further comprises a driving voltage line extending in parallel with a data line from among the data lines,
each of the plurality of compensation capacitors includes:
a first capacitor electrode electrically connected to the data line; and
a second capacitor electrode electrically connected to the driving voltage line.

6. The display device of claim 5, wherein the first capacitor electrodes of the plurality of compensation capacitors are on a first layer and electrically connected to each other, and the second capacitor electrodes of the plurality of compensation capacitors are on a second layer on the first layer and electrically connected to each other.

7. The display device of claim 1, wherein the first non-display area comprises:
a pad portion;
a plurality of first fan-out lines connected to the pad portion; and
a first circuit part connected between the plurality of first fan-out lines and the plurality of data lines, and
the second non-display area comprises:
a plurality of second fan-out lines connected to the pad portion;
a second circuit part connected to the plurality of second fan-out lines; and
a plurality of lead lines connected between the second circuit part and the second display area.

8. The display device of claim 7, wherein the second circuit part comprises:
a demultiplexer configured to output a data voltage received from one of the plurality of second fan-out lines to the plurality of lead lines; and
a scan driver configured to generate a scan signal based on a scan control signal received from the pad portion.

9. The display device of claim 8, wherein the plurality of lead lines extend from the demultiplexer to the second display area, overlap the plurality of load matching units, and are electrically connected to the plurality of data lines and the load matching unit through a contact portion.

10. The display device of claim 8, wherein the second display area further comprises a plurality of gate lines crossing the plurality of data lines, and
the plurality of lead lines are configured to supply the scan signal received from the scan driver to the plurality of gate lines of the second display area.

11. The display device of claim 1, further comprising a third non-display area adjacent to the second display area and the second non-display area, and including a third circuit part.

12. The display device of claim 11, wherein the third circuit part comprises:
a scan driver configured to generate a scan signal based on a scan control signal; and
an antistatic circuit configured to remove static electricity flowing from the outside.

13. The display device of claim 11, wherein the third circuit part comprises:
a plurality of scan drivers configured to generate a scan signal based on a scan control signal;
an antistatic circuit configured to remove static electricity flowing from the outside; and
a plurality of load matching units connected to the plurality of data lines of the second display area.

14. The display device of claim 13, wherein the plurality of load matching units are between the plurality of scan drivers.

15. A display device comprising:
a first display area including a plurality of data lines extending in a first direction;
a second display area at one side of the first display area, comprising a plurality of data lines extending in the first direction, the second display area having a width smaller than a width of the first display area in the first direction; and
a non-display area surrounding the first and second display areas,
wherein the non-display area comprises a plurality of load matching units including a plurality of compensation capacitors respectively connected to the plurality of data lines of the second display area.

16. The display device of claim 15, wherein the second display area comprises a plurality of data lines having lengths different from each other, and
each of the plurality of load matching units includes a number of the compensation capacitors, which is different depending on the lengths of the data lines of the second display area.

17. The display device of claim 15, wherein the second display area further comprises a driving voltage line extending in parallel with the data lines, and
each of the plurality of compensation capacitors includes:
a first capacitor electrode electrically connected to the data line; and
a second capacitor electrode electrically connected to the driving voltage line.

18. A display device comprising:
a first display area including a plurality of data lines extending in a first direction;
a second display area at one side of the first display area, comprising a plurality of data lines shorter than the data lines of the first display area;
a first non-display area adjacent to the first display area, comprising a first circuit part;
a second non-display area adjacent to the second display area, comprising a second circuit part and a plurality of load matching units between the second circuit part and the second display area and connected to each of the plurality of data lines of the second display area; and
a third non-display area adjacent to the second display area and the second non-display area, comprising a third circuit part.

19. The display device of claim 18, wherein the first non-display area further comprises a pad portion and a plurality of first fan-out lines connected between the pad portion and the first circuit part, and
the second non-display area further comprises a plurality of second fan-out lines connected to the pad portion, and a plurality of lead lines connected between the second circuit part and the second display area to overlap the plurality of load matching units.

20. The display device of claim 19, wherein the second circuit part comprises:
a demultiplexer configured to output a data voltage received from one of the plurality of second fan-out lines to the plurality of lead lines; and
a scan driver configured to generate a scan signal based on a scan control signal received from the pad portion.
